(19) United States
(12) Patent Application Publication
(10) Pub. No.: US 2015/0022631 A1
(43) Pub. Date: Jan. 22, 2015

(54) CONTENT-AWARE DISPLAY ADAPTATION METHODS AND EDITING INTERFACES AND METHODS FOR STEREOSCOPIC IMAGES

(71) Applicant: HTC Corporation, Taoyuan City (TW)

(72) Inventors: Che-Han CHANG, Taoyuan City (TW); Yung-Yu CHUANG, Taipei City (TW); Chia-Kai LIANG, Mountain View, CA (US)

(21) Appl. No.: 13/944,525

(22) Filed: Jul. 17, 2013

(51) Int. Cl. H04N 13/00

(52) U.S. Cl. CPC H04N 13/0033; H04N 13/0018
USPC 348/43

(57) ABSTRACT

Content-aware display adaptation methods for stereoscopic images and editing interfaces and methods are provided. First, the saliency maps are estimated for stereoscopic images. Each image is represented as a grid mesh, and a per-quad importance is measured based on the saliency maps. Then, features are detected matched between the images. An energy function is defined according to the saliency maps, the matched features, data for the grid mesh, and specification of a target display. The energy function consists of at least a disparity consistency energy and/or an alignment energy. The energy function is minimized to obtain two sets of deformed vertex positions for the images. The control indicator displayed in an operational interface is tuned via a touch-sensitive display unit, such that the energy function is accordingly modified, and corresponding deformed stereoscopic images are displayed.

### BACKGROUND OF THE INVENTION

1. Field of the Invention

The disclosure relates generally to image display adaptation, and, more particularly to content-aware display adaptation methods and related editing interfaces and methods for stereoscopic images.

2. Description of the Related Art

The rapid deployment of stereoscopic equipment like displays and cameras will soon lead to a demand for users to be able to manipulate stereoscopic media similar to the way they manipulate 2D media. Stereoscopic media delivers not only an additional dimension and added enjoyment, but also additional challenges and constraints in creating a comfortable and enjoyable 3D experience. Because they do not address these constraints, naive extensions of existing 2D media manipulation algorithms usually fail to deliver a comfortable 3D viewing experience. Thus, nontrivial adjustments are often required to accommodate new constraints and take advantage of new opportunities.

Most stereoscopic displays rely on the principle of stereopsis, in which human eyes are horizontally separated and the separation causes an interocular difference in the images projected onto the left and right retinas. When each eye is presented with the proper image, humans perceive depth by fusing the left and the right images. The fusibility of stereoscopic images depends not only on properly calibrated displays but also depends heavily on perfect matches between the left and right images. Mismatches in image pairs, or binocular asymmetries, can lead to serious viewing discomfort. In severe cases, the user experiences diplopia (double vision) and 3D scene perception is totally disrupted or highly inaccurate. Even if the user is able to perceive a consistent 3D view, the effort required to resolve conflicts caused by binocular imperfections can lead to serious fatigue, eyestrain, and headache, and may reduce the sense of realism. Such mismatch is often caused by asymmetrical optical geometry or photometric characteristics. For example, the viewer may experience viewing discomfort if the left and the right images are misaligned horizontally.

Due to the diversity among display resolutions and aspect ratios, similar to 2D media, binocular images require adaptation to be displayed properly on different devices. In addition to adapting to the device resolution and aspect ratio (retargeting along the x and y directions on the screen plane), for stereoscopic displays, we often must adapt images to its comfort zone (that is, depth adaptation along the z direction perpendicular to the display). In addition to adapting to different displays, depth adaptation is often required for binocular images with excessive depth ranges.

Recently, the problem of 2D image and video retargeting, that is, adapting the images or videos for displays with different sizes and aspect ratios, has received considerable attentions. While traditional scaling and cropping methods can easily cause significant distortions or information loss, modern content-aware approaches take into account the saliency distribution of the image and attempt to keep the salient features uncontaminated. These approaches can roughly be categorized as discrete approaches or continuous approaches. The seam carving method is a well-known discrete approach that uses dynamic programming to find the optimal seam to be removed in an image according to its saliency map. A seam is a path of pixels from top to bottom or side to side. However, because of their discrete nature, those approaches do not preserve structured objects well, and lead to disturbing artifacts. For continuous approaches, several warping-based methods have been proposed. These methods treat retargeting as a mesh deformation/warping problem, in which prominent regions are constrained so that their shapes are preserved as much as possible while less salient areas are allowed to be distorted more. The optimal warping field is usually obtained by minimizing certain energy functions. A direct application of these 2D content-aware retargeting algorithms to binocular images could, however, lead to visual discomfort because the binocular disparity cues in the input are not properly preserved. Moreover, stereoscopic content introduces an additional retargeting dimension along the depth axis.

For retargeting along the depth axis, or controlling depth perception in the 3D content, researchers in the stereoscopic display community have proposed a variety of techniques, such as false eye separation, alpha-false eye separation, image scaling, image shifting, view scaling, etc. Unfortunately, none of these methods is content-aware, and hence they may cause large distortions on the image plane. Because most methods use global image transformations, they have limited control over depths or disparities. For example, an approach suggested using a uniform adaptation that scales the image uniformly. However, this can lead to distortion of the object shape if the horizontal and vertical scaling factors are different. Moreover, the perceived depth range varies with the scaling factor.

### BRIEF SUMMARY OF THE INVENTION

Content-aware display adaptation methods and related editing interfaces and methods for stereoscopic images are provided. The present method first detects a sparse set of robust correspondence points and then optimizes the warping fields of the image pair according to the target display parameters, correspondence constraints, and other constraints that prevent the results from distortions. The present method can achieve various retargeting scenarios, including changing the display size, aspect ratio, allowable depth range, and viewing configuration. It can also achieve effects not supported in traditional depth adaptation methods, such as changes to the scene depth that do not affect its scale. In addition, by modeling the user interaction as constraints, the present system can be extended to an interactive stereoscopic image editing system. The user can specify the transformation of the disparity/depth values, and the system accordingly warps the input to generate a new stereoscopic image. The user can also select a single object and specify its position, depth, or even explicit 3D location. The system automatically identifies the depths of other regions and warps the input to match user's intention. The resultant system is the first content-aware system to simultaneously allow retargeting, depth adaptation, and interactive editing of stereoscopic images.

In an embodiment of a content-aware display adaptation method for stereoscopic images for use in an electronic device, stereoscopic images comprising at least one image pair of a left image and a right image are provided. Then, saliency maps are estimated for the image pair using a graph-based visual saliency algorithm. Each image is represented as a grid mesh and a per-quad importance is measured for each quad based on the saliency maps. Features of the left image and the right image are detected, and the detected features are matched between the left image and the right image. An energy function is defined according to the saliency maps, the matched features, data for the grid mesh, and specification of a target display, wherein the energy function consists of at least a disparity consistency energy, which ensures the disparities of the matched features are manipulated in a consistent way. Then, the energy function is minimized to obtain two sets of deformed vertex positions for the left image and the right image.

In an embodiment of a content-aware display adaptation method for stereoscopic images for use in an electronic device, stereoscopic images comprising at least one image pair of a left image and a right image are provided. Then, saliency maps are estimated for the image pair using a graph-based visual saliency algorithm. Each image is represented as a grid mesh and a per-quad importance is measured for each quad based on the saliency maps. Features of the left image and the right image are detected, and the detected features are matched between the left image and the right image. An energy function is defined according to the saliency maps, the matched features, data for the grid mesh, and specification of a target display, wherein the energy function consists of at least an alignment energy, which ensures the features are horizontally aligned on the same scanline after deformation. Then, the energy function is minimized to obtain two sets of deformed vertex positions for the left image and the right image

In some embodiments, SIFT (Scale Invariant Feature Transform) features are detected from both the left image and the right image, and the matched features are verified using a fundamental matrix estimated using RANSAC (RANdom SAmple Consensus). In some embodiments, cluttered features are further removed from the detected features using non-maximum suppression.

In some embodiments, the disparity consistency energy comprises a global scaling factor of disparity and a shift factor, which are used to maintain the relative depths of the features.

In some embodiments, the energy function further consists of at least an alignment energy, which ensures the features are horizontally aligned on the same scanline after deformation.

In some embodiments, the energy function further consists of at least a distortion energy and a line bending energy, wherein the distortion energy prevents important quads in the grid mesh from being non-uniformly scaled, and the line bending energy maintains the angle between an original edge and an deformed edge corresponding to each quad to be as small as possible.

In an embodiment of an editing method for stereoscopic images for use in an electronic device, an operational interface is displayed on a touch-sensitive display unit of the electronic device, wherein the operational interface displays stereoscopic images comprising at least one image pair of a left image and a right image, and has at least one control indicator. An input corresponding to the control indicator is received via the touch-sensitive display unit. An energy function is modified based on the input, wherein the energy function is defined according to saliency maps, matched features for the stereoscopic images, data for a grid mesh corresponding to each image, and specification of the touch-sensitive display unit. The energy function is minimized to obtain two sets of deformed vertex positions of the grid mesh for the left image and the right image. Then, the deformed stereoscopic images are displayed on the touch-sensitive display unit based on the deformed vertex positions.

In some embodiments, the energy function consists of at least a disparity consistency energy, which ensures the disparities of the matched features are manipulated in a consistent way, and the disparity consistency energy comprises a global scaling factor of disparity or a shift factor, which are used to maintain the relative depths of the features, in which the control indicator corresponds to the global scaling factor or the shift factor.

In some embodiments, the input is performed by touching and scrolling the control indicator of the operational interface on the touch-sensitive display unit.

Content-aware display adaptation methods and related editing interfaces and methods for stereoscopic images may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 shows a typical viewing configuration for stereoscopic displays;

FIG. 2 is a flowchart of an embodiment of a content-aware display adaptation method for stereoscopic images of the invention;

FIG. 3A illustrates an example of an input binocular image pair;

FIG. 3B illustrates the saliency maps for the image pair in FIG. 3A;

FIG. 3C illustrates the quad importance maps for the image pair in FIG. 3A;

FIG. 3D illustrates the image pair in FIG. 3A with grid meshes and feature points;

FIG. 3E illustrates the retargeted image pair with deformed grid meshes and relocated feature points;

FIG. 3F illustrates the retargeted image pair for the image pair in FIG. 3A;

FIG. 4 is a flowchart of an embodiment of an editing method for stereoscopic images of the invention; and

FIGS. 5A to 5D illustrate an example of an operational interface for editing stereoscopic images according to the editing method for stereoscopic images of the invention.

### DETAILED DESCRIPTION OF THE INVENTION

Content-aware display adaptation methods and related editing interfaces and methods for stereoscopic images are provided.

Before explaining the present invention, the basic model for stereovision, in particular the relationship between perceived depth and image disparity is introduced, and the problem of stereoscopic image retargeting is then formulated.

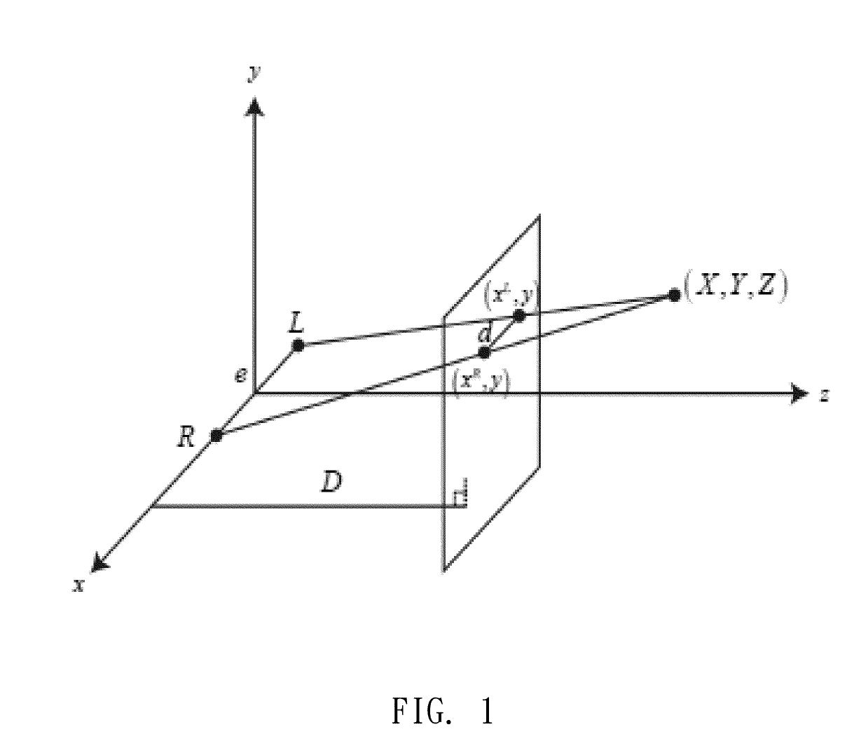

FIG. 1 shows a typical viewing configuration for stereoscopic displays. Here L and R denote the left and right eye of the viewer, respectively, e is the interocular distance between two eyes (this averages about 6.5 cm for adults), and D is the viewing distance to the screen. Without loss of generality, it is assumed that the eyes are aligned on the x-axis of the world coordinate and the origin is their midpoint. Note that, in the present application, it is to change the apparent depth (the perceived depth) to the viewer.

A stereoscopic display delivers two different images to two eyes, and the viewer's brain fuses these images to achieve 3D perception. Therefore, to have a perception of point P at [Xₚ, Yₚ, Zₚ]^{T} in 3D space, its projection is p^{L}=[xₚ^{L}, yₚ]^{T} on the left image and p^{R}=[xₚ^{R}, yₚ]^{T} on the right image, where

$$\begin{matrix}{x}_{p}^{L} = ( {X}_{p} + \frac{e}{2} ) \frac{D}{{Z}_{p}} - \frac{e}{2} , & ( 1 ) \\ {x}_{p}^{R} = ( {X}_{p} - \frac{e}{2} ) \frac{D}{{Z}_{p}} + \frac{e}{2} , and & ( 2 ) \\ {y}_{p} = {Y}_{p} \frac{D}{{Z}_{p}} . & ( 3 )\end{matrix}$$

The horizontal shift of pixel p between the left and right eyes, dₚ=xₚ^{R}−xₚ^{L}, is usually denoted as disparity and is related to its depth Zₚ by

$${d}_{p} = {x}_{p}^{R} - {x}_{p}^{L} = e ( 1 - \frac{D}{{Z}_{p}} ) . \qquad ( 4 )$$

Similarly, given the two corresponding points p^{L}=[xₚ^{L}, yₚ]^{T} and p^{R}=[xₚ^{R}, yₚ]^{T} on the left and right images, the viewer perceives a 3D point P at [Xₚ, Yₚ, Zₚ]^{T}:

$${[ {X}_{p} , {Y}_{p} , {Z}_{p} ]}^{T} = {\frac{e}{e - {d}_{p}} [ \frac{{x}_{p}^{L} + {x}_{p}^{R}}{2} , {y}_{p} , D ]}^{T} . \qquad ( 5 )$$

In particular, the perceived depth Zₚ of the point is related to the disparity dₚ as

$${Z}_{p} = \frac{eD}{e - {d}_{p}} . \qquad ( 6 )$$

From Eq. (6), it is shown that the perceived depth is related nonlinearly to disparity.

It is noted that, when the image is transformed, the disparities change subtly. When the image is stretched linearly along the x-axis, the disparities increase linearly. However, the disparities are unaffected by y-axis stretch. Therefore, when the real estate of the display increases, the depth range of the displayed image increases accordingly. In the worst case, the object can be pushed beyond infinity (i.e., dₚ>e in Eq. (6)), leading to an incorrect and irritating 3D effect. Similarly, when the aspect ratio changes, the disparities change accordingly. These phenomena seriously hinder the distributions of stereoscopic content across different medium. For example, a striking 3D effect in the cinema may look flat and boring on a 3D mobile phone, and a 3D effect that looks good on a mobile phone may lead to diplopia in the cinema.

Another crucial parameter of a stereoscopic display is its comfort depth range, or called comfort zone. When viewing a stereoscopic display, our eyes fixate on the virtual 3D object, providing the convergence cue for 3D perception. We must focus on the screen for sharp images, in which the lack of an accommodation cue (change of focus) informs the brain that the display is flat. This conflict between accommodation and convergence cues causes visual discomfort, especially for excessive disparity values. Thus the comfort zone is that range of depths where the conflict can be tolerated. Depth outside that zone can cause diplopia or blur. Because of optics properties, viewing distances, and other factors, different displays have different comfort zones. Even for the same viewing configuration, the comfort zone can vary among individuals.

For these reasons, depth adaptation is required to ensure a vivid and enjoyable 3D experience. Given a stereoscopic image pair captured for a specific viewing configuration, the depth adaptation process attempts to adjust the content, such that the 3D perception delivered in another viewing configuration is identical or similar to the original one. The method most commonly used in commercial stereo displays is the image shifting method. By horizontally shifting one of the images, we can increase/decrease the disparities and thus the depths. However, because the mapping between the disparity and 3D coordinate is nonlinear, this simple method causes undesirable miniaturization or gigantism effects. Thus, when image shifting is used to adjust the binocular image, the perceived scene scale changes accordingly as an unwanted side effect. Other methods that rely on global image transformations have the same drawback.

Theoretically, for perfect depth adaptation, one should first reconstruct the scene from the input images, transform the scene to fit the display comfort zone, and finally re-project the scene to obtain the new stereoscopic images. However, this approach requires dense scene geometry, which is typically noisy or even unavailable. Moreover, in the scene transformation and re-projection process, the system must recover scene content occluded in the original input, which itself is a challenging and unsolved research problem. One solution is to sample more data during acquisition by using multi-rigging techniques or camera arrays, which allow for better scene reconstruction. If the footage is computer-generated, it is possible to re-render it for each display. However, these approaches are expensive for amateurs. Another solution is to edit the stereoscopic content by manual authoring, which can be very time-consuming. As described, the present method can avoid these difficulties and still generate appealing results.

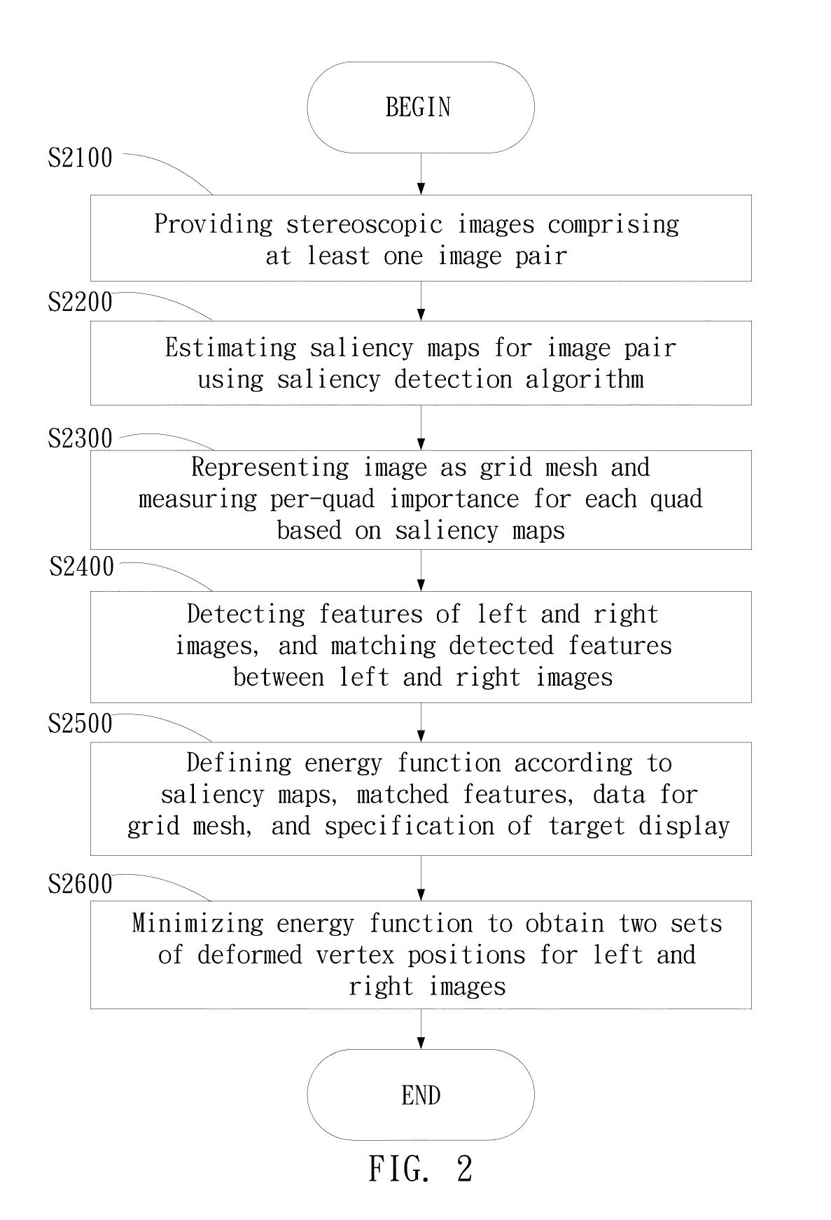

FIG. 2 is a flowchart of an embodiment of a content-aware display adaptation method for stereoscopic images of the invention. The content-aware display adaptation method for stereoscopic images can be used in an electronic device with a stereoscopic image playback capability, such as computers, TVs, projectors, and mobile devices such as a PDA, a smart phone, a game device, an MID, a Netbook, or other handheld devices.

In step S2100, stereoscopic images comprising at least one binocular image pair {I^{L}, I^{R}} of a left image and a right image are provided. In step S2200, saliency maps {φ^{L}, φ^{R}} are estimated for the image pair {I^{L}, I^{R}} using a saliency detection algorithm. It is noted that, the saliency maps {φ^{L}, φ^{R}} shows the pre-pixel importance of the image pair {I^{L}, I^{R}}. It is understood that, in some embodiments, the saliency detection algorithm may be a graph-based visual saliency algorithm, such as a frequency-tuned salient region detection method. It is noted that, the frequency-tuned salient region detection method is an example of the present invention, and the present invention is not limited thereto. In step S2300, each image is represented as a grid mesh and a per-quad importance is measured for each quad based on the saliency maps {φ^{L}, φ^{R}}. It is understood that, in some embodiments, the per-quad importance for each quad is measured by averaging and normalizing the per-pixel saliency based on the saliency maps {φ^{L}, φ^{R}}. Then, in step S2400, features of the left image and the right image are detected, and the detected features are matched between the left image and the right image. It is noted that, in some embodiments, SIFT (Scale Invariant Feature Transform) features are detected from both the left image and the right image. For each feature point in I^{L}, its best match in I^{R} is found and verified using a fundamental matrix estimated using RANSAC (RANdom SAmple Consensus). Further, in some embodiments, cluttered features can be removed from the detected features using non-maximum suppression. In step S2500, an energy function is defined according to the saliency maps, the matched features, data for the grid mesh, and specification of a target display. It is noted that, the energy function can comprise constrains for generation of warping fields. In the present method, the energy function consists of four parts: distortion energy Ψ_{d} , line bending energy Ψ_{b}, alignment energy Ψₐ, and disparity consistency energy Ψ_{c}. It is noted that, in the present method, the energy function can consist of at least one of the above energies. Details of the respective energy are discussed as follows. It is noted that, the set of n matched features is denoted as F={(fᵢ^{L}, fᵢ^{R})|i=1 . . . n}, and {V^{L}, E^{L}, Q^{L}} and {V^{R}, E^{R}, Q^{R}} denotes the grid meshes for both images, where V, E and Q represent the vertex sets, edge sets, and quad face sets, respectively.

Distortion Energy

Distortion energy prevents important quads from being non-uniformly scaled. For each quad q with four edges E(q), the distortion energy for the quad is defined as

$${Ψ}_{q} ( q ) = {\sum }_{( i , j ) ∈ E ( q )} {‖ ( {\tilde{v}}_{i} - {\tilde{v}}_{j} ) - {s}_{q} ( {v}_{i} - {v}_{j} ) ‖}^{2} , \qquad ( 7 )$$

where s_{q} is the scale factor defined by \tilde{v}ᵢ and vᵢ. The total distortion energy is the weighted sum of the distortions of all quads in both views, which is defined as

$${Ψ}_{d} = {\sum }_{q ∈ {Q}^{L}} ϖ ( q ) {Ψ}_{q} ( q ) + {\sum }_{q ∈ {Q}^{R}} ϖ ( q ) {Ψ}_{q} ( q ) , \qquad ( 8 )$$

where ω̅(q) is the quad importance of q. ω̅(q) is initialized as the average of the saliency values of all pixels in q and then normalized to [ε,1], where ε is a small constant (we set ε=0.05).

Line Bending Energy

In addition to non-uniform scaling, the bending of the grid edges is minimized. That is, the angle between the original edge e and deformed edge \tilde{e} is expected to be as small as possible. It is understood that, in the present method, a new linear line bending energy is proposed. Consider edge e which has the two vertices vᵢ and vⱼ and its deformed version \tilde{e}=(\tilde{v}ᵢ, \tilde{v}ⱼ). Vectors are defined, in which e=vᵢ−vⱼ and \tilde{e}=\tilde{v}ᵢ−\tilde{v}ⱼ. The following term is used to approximate the angle between e and \tilde{e}:

Δ(\tilde{e})=∥sₑe−\tilde{e}∥², (9)

where sₑ is a scale parameter expected to be optimized. Taking the partial derivative of Δ with respect to sₑ, the optimal sₑ* is obtained as

sₑ*=(e^{T}e)⁻¹e^{T}\tilde{e}. (10)

Substituting sₑ* back into Eq.(9) yields a function of \tilde{e}:

$$\begin{matrix}Δ ( e ) = {‖ {s}_{e} e - \tilde{e} ‖}^{2} \\ = {‖ {e ( {e}^{T} e )}^{- 1} {e}^{T} \tilde{e} - \tilde{e} ‖}^{2} , \\ = {‖ C \tilde{e} ‖}^{2}\end{matrix} \qquad ( 11 )$$

Where C=e(e^{T}e)⁻¹e^{T}−I and I is the identity matrix.

Eq. (11) can be further rewritten as a function of \tilde{v}ᵢ and \tilde{v}ⱼ:

$$Δ ( {\tilde{v}}_{i} , {\tilde{v}}_{j} ) = {‖ C [ \begin{matrix}1 & 0 & - 1 & 0 \\ 0 & 1 & 0 & - 1\end{matrix} ] [ \begin{matrix}{\tilde{v}}_{i} \\ {\tilde{v}}_{j}\end{matrix} ] ‖}^{2} . \qquad ( 12 )$$

Finally, the total line bending energy is defined as

$${Ψ}_{b} = {\sum }_{( i , j ) ∈ {E}^{L}} Δ ( {\tilde{v}}_{i}^{L} , {\tilde{v}}_{j}^{L} ) + {\sum }_{( i , j ) ∈ {E}^{R}} Δ ( {\tilde{v}}_{i}^{R} , {\tilde{v}}_{j}^{R} ) .. \qquad ( 13 )$$

Alignment Energy

The alignment energy is used to ensure vertical alignment of features after deformation to avoid binocular asymmetries. The alignment energy Ψₐ is defined as:

$${Ψ}_{a} = \frac{1}{n} {\sum }_{i = 1}^{n} {( {\tilde{f}}_{i}^{L} [ y ] - {\tilde{f}}_{i}^{R} [ y ] )}^{2} , \qquad ( 14 )$$

where notation v[y] represents the y component of the vector v, and similarly v[x] for the x component.

Note that, the relocated feature \tilde{f} can be expressed as a linear combination of the vertices after deformation \tilde{v}ᵢ using barycentric coordinates. It is assumed that, before deformation, the feature f is related to the vertices vᵢ of the quad where it is located in as f=Σᵢ₌₁⁴βᵢvᵢ, where βᵢ are the barycentric coordinates. The relocated feature \tilde{f} can then be written as a linear combination of deformed vertices, \tilde{f}=Σ₁₌₁⁴βᵢ\tilde{v}ᵢ, using the same barycentric coordinates. Therefore, Eq. (14) can be written as a function of the warped vertices \tilde{v}ᵢ.

Disparity Consistency Enemy

Disparity consistency energy is used to ensure that the disparities of features are manipulated in a consistent way to avoid distortion of the perceived depths. Two different disparity consistency energies are provided, in which each of which is useful for different applications. The first energy is an attempt to keep the perceived depths identical to those before deformation. This is useful for the situation when the image size changes while the viewing configuration is the same. In such cases, the same disparity is expected to be maintained, so that the perceived depth is the same after resizing. For this option, the disparity consistency energy Ψ_{c} is defined as

$${Ψ}_{c} = \frac{1}{n} {\sum }_{i = 1}^{n} {( {d}_{i} - {\tilde{d}}_{i} )}^{2} , \qquad ( 15 )$$

where dᵢ=fᵢ^{R}[x]−fᵢ^{L}[x] and \tilde{d}ᵢ=\tilde{f}ᵢ^{R}[x]−\tilde{f}ᵢ^{L}[x] are the disparity values in the pixel domain before and after deformation respectively.

In cases in which viewing configurations change, the disparity values should be scaled and shifted accordingly. Thus, for the second option, the relative depths of the feature points in the input images are expected to be maintained by finding a monotonic increasing mapping of depths. In this way, the depth order of the objects is preserved but their absolute depths are flexible. A trivial choice is to find a proper 1D similarity transform of depths to maintain the relative depths. However, this makes the energy term nonlinear to deformed features. We choose instead to find a proper 1D similarity transformation of disparities to maintain the relative depths:

$${Ψ}_{c} = \frac{1}{n} {\sum }_{i = 1}^{n} {( ( {s}_{d} {d}_{i} + {t}_{d} ) - {\tilde{d}}_{i} )}^{2} , \qquad ( 16 )$$

Where s_{d} represents the global scaling factor of disparity and t_{d} represents the shift. Using the same approach used to obtain the optimal sₑ* in Eq. (9), s_{d} and t_{d}, can be eliminated from Eq. (16) and turned into a function of deformed features, each of them a linear combination of deformed vertices. After defining matrix E and vector \tilde{E} as

$$E = [ \begin{matrix}{d}_{1} & 1 \\ {d}_{2} & 1 \\ ⋮ & ⋮ \\ {d}_{n} & 1\end{matrix} ] and E = [ \begin{matrix}{\tilde{d}}_{1} \\ {\tilde{d}}_{2} \\ ⋮ \\ {\tilde{d}}_{n}\end{matrix} ] ,$$

Eq. (16) is re-written as

$${Ψ}_{c} = \frac{1}{n} {‖ E [ \begin{matrix}{s}_{d} \\ {t}_{d}\end{matrix} ] - \tilde{E} ‖}^{2} , \qquad ( 17 )$$

and the optimal scale s_{d}* and shift t_{d}* are

$$[ \begin{matrix}{s}_{d} \\ {t}_{d}\end{matrix} ] = {( {E}^{T} E )}^{- 1} {E}^{T} \tilde{E} . \qquad ( 18 )$$

By substituting s_{d}* and t_{d}* back into Eq. (17), the energy Ψ_{c} can be written as a function of deformed features:

$${Ψ}_{c} = \frac{1}{n} {‖ BA \tilde{f} ‖}^{2} , \qquad ( 19 )$$

where B=E(E^{T}E)⁻¹E^{T}-I, A=[−I|I] and

$$f = [ \begin{matrix}{\tilde{f}}_{1}^{L} [ x ] \\ ⋮ \\ {\tilde{f}}_{n}^{L} [ x ] \\ {\tilde{f}}_{1}^{R} [ x ] \\ ⋮ \\ {\tilde{f}}_{n}^{R} [ x ]\end{matrix} ] .$$

Again, \tilde{f} can be rewritten in terms of the deformed vertices. Note that the optimal scale and shift can be integrated into the energy function and determined automatically by optimization.

As described, the energy function can consist of at least one of the above energies. In some embodiments, the final energy Ψ is the sum of the four defined energy terms:

Ψ=Ψ_{d}+λ_{b}Ψ_{b}+λₐ+λ_{c}Ψ_{c}. (20)

In some embodiments, the coefficients can be set as: λ_{b}=1, λₐ=10 and λ_{c}=500. The above energy function is an interplay between 2D shape conservation and depth preservation.

After the energy function is defined, in step S2600, the energy function is minimized to obtain two sets of deformed vertex positions for the left image and the right image. It is understood that, these terms are all functions of the deformed grid vertices \tilde{v}ᵢ^{L} and \tilde{v}ᵢ^{R}. Minimizing Ψ corresponds to solving a least-squares problem and leads to a linear system involving only \tilde{v}ᵢ^{L} and \tilde{v}ᵢ^{R}. By finding the sets of deformed vertices \tilde{v}ᵢ^{L} and \tilde{v}ᵢ^{R} which minimize Ψ and satisfy the boundary conditions, both images are warped to the target resolution while maintaining the 3D shapes of important objects. Then, the full warping fields are interpolated using bilinear interpolation according to the deformed vertex positions and the input image pair.

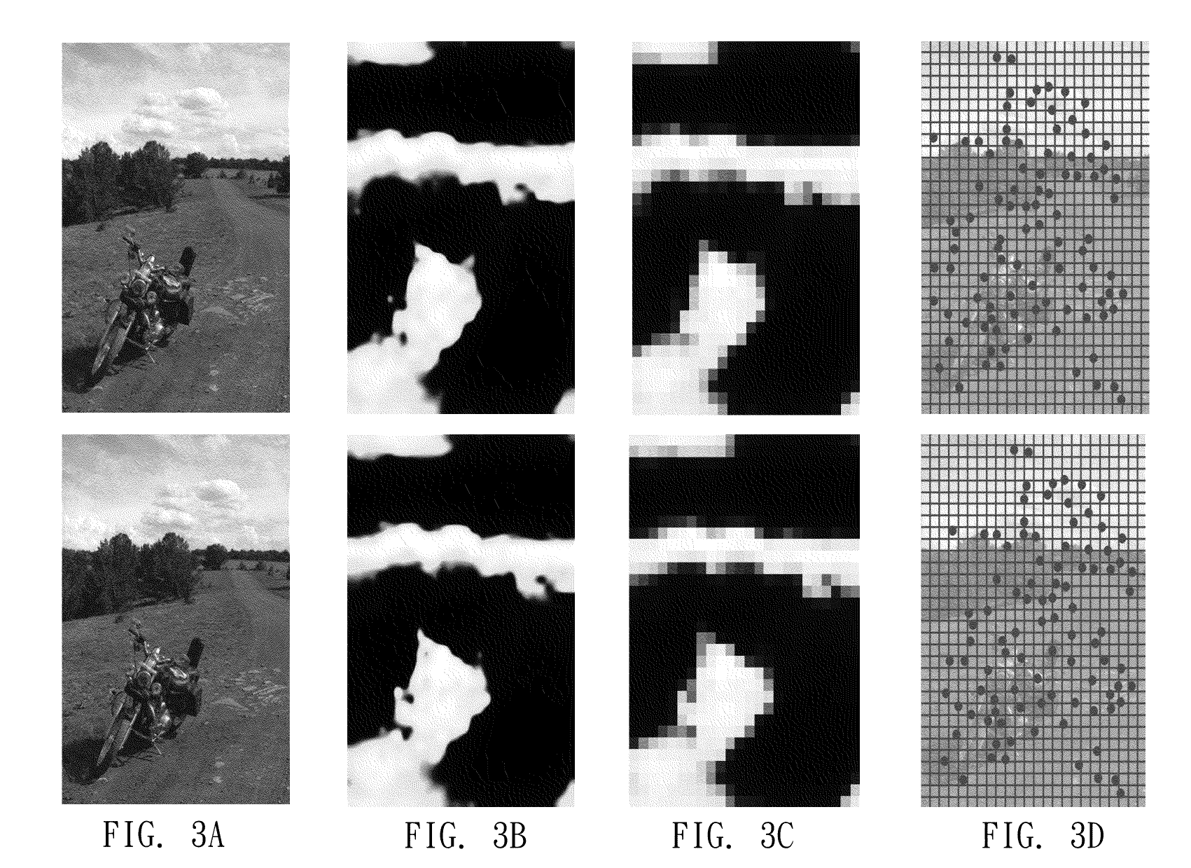

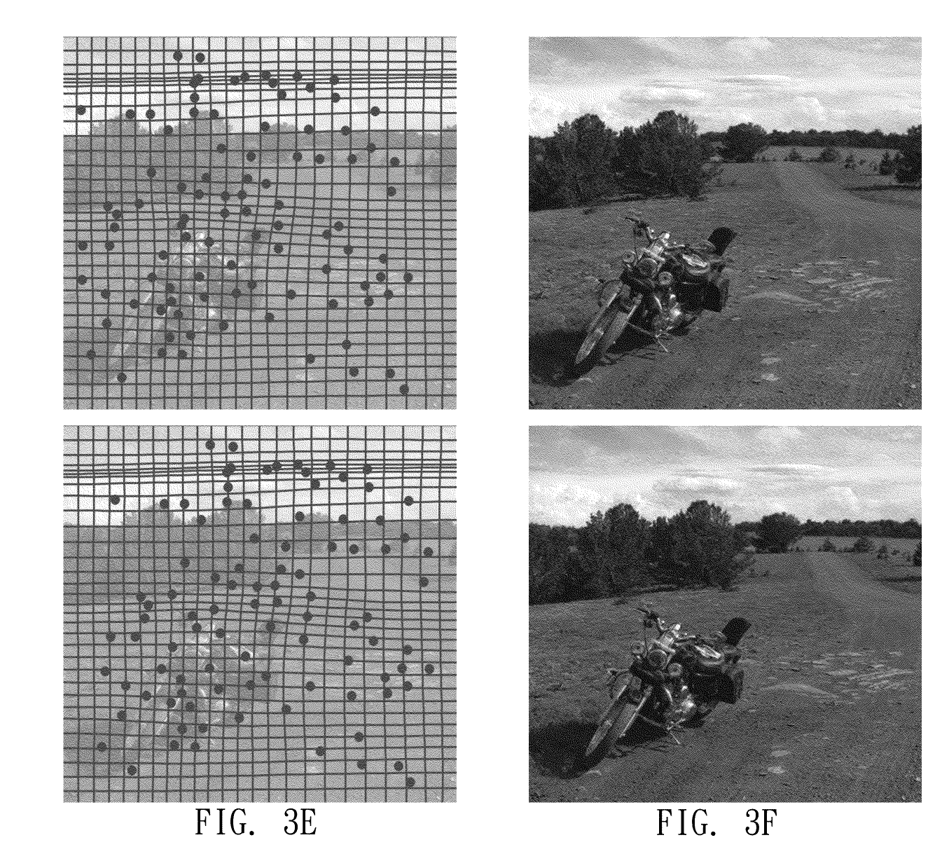

An example follows. FIGS. 3A to 3F illustrate the overview of the present method, in which the top row shows the left view and second row shows the right view. First, an input binocular image pair is provided, as shown in FIG. 3A. Then, a saliency detection algorithm is applied to the binocular image pair to measure the per-pixel importance of the image pair (FIG. 3B). Then, each image is represented as a grid mesh and the per-quad importance is measured by averaging and normalizing the per-pixel saliency (FIG. 3C). Next, feature extraction and matching are applied to the image pair to obtain sparse matched pairs between the left and right images (FIG. 3D). Given the retargeting parameters, the warping functions on the mesh vertices are obtained by optimizing an energy function (FIG. 3E). Finally, the full warping fields and the final output are interpolated using bilinear interpolation (FIG. 3F).

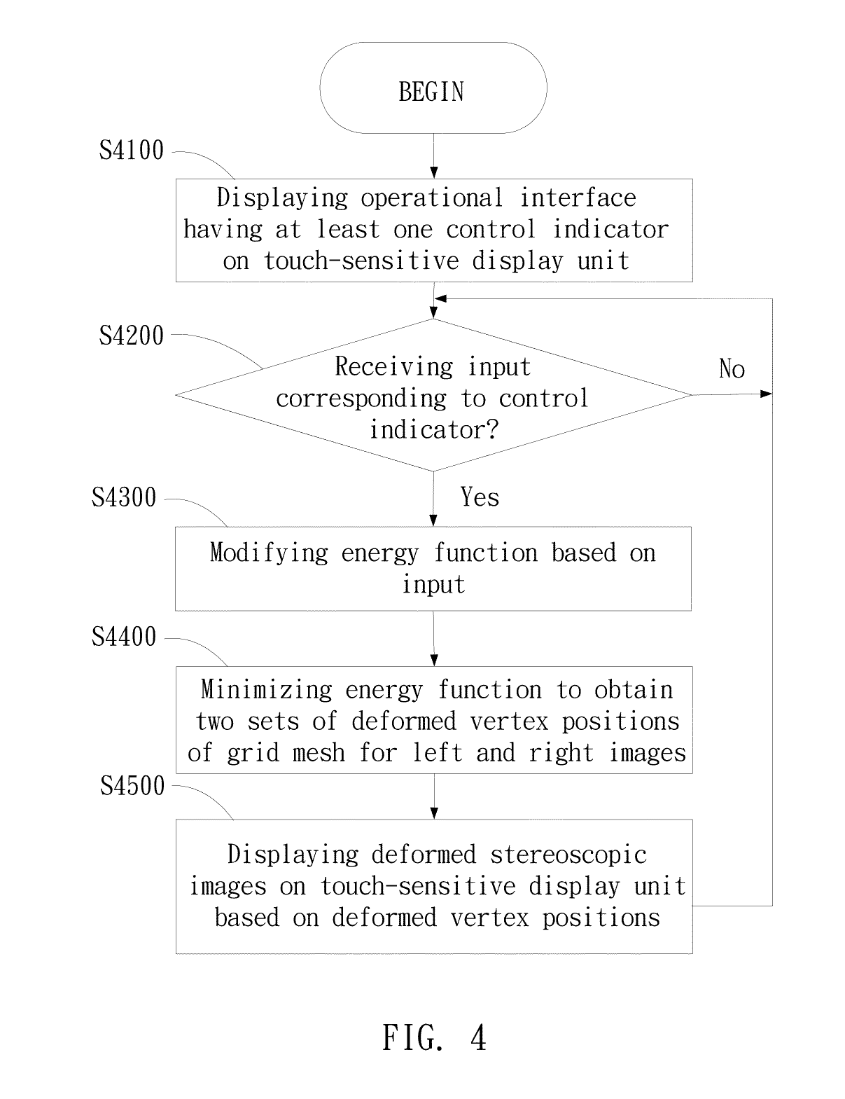

FIG. 4 is a flowchart of an embodiment of an editing method for stereoscopic images of the invention. The editing method for stereoscopic images can be used in an electronic device, such as computers, and mobile devices such as a PDA, a smart phone, an MID, a Netbook, or other handheld devices.

In step S4100, an operational interface is displayed on a touch-sensitive display unit of the electronic device. The operational interface displays stereoscopic images comprising at least one image pair of a left image and a right image, and has at least one control indicator. It is noted that, the at least one control indicator corresponds to at least one factor in an energy function. In step S4200, it is determined whether an input corresponding to the control indicator is received via the touch-sensitive display unit. It is understood that, in some embodiments, the input is performed by touching and scrolling the control indicator of the operational interface on the touch-sensitive display unit. If no input is received (No in step S4200), the procedure remains at step S4200. If an input corresponding to the control indicator is received via the touch-sensitive display unit (Yes in step S4200), in step S4300, an energy function is modified based on the input. It is noted that, the energy function is defined according to saliency maps, matched features for the stereoscopic images, data for a grid mesh corresponding to each image, and specification of the touch-sensitive display unit, and the energy function comprises distortion energy Ψ_{d}, line bending energy Ψ_{b}, alignment energy Ψₐ, and/or a disparity consistency energy Ψ_{c}. It is noted that, in the present method, the energy function can consist of at least one of the above energies. The details of the energy function and the corresponding energies are omitted here. In some embodiments, the factor corresponding to the control indicator may be the global scaling factor and/or the shift factor in the disparity consistency energy. The input corresponding to the control indicator can be used to modify the optimal value for the factor. Then, in step S4400, the energy function is minimized to obtain two sets of deformed vertex positions of the grid mesh for the left image and the right image. Similarly, minimizing Ψ corresponds to solving a least-squares problem and leads to a linear system involving only \tilde{v}ᵢ^{L} and \tilde{v}ᵢ^{R}. By finding the sets of deformed vertices \tilde{v}ᵢ^{L} and \tilde{v}ᵢ^{R} which minimize Ψ and satisfy the boundary conditions, both images are warped to the target resolution while maintaining the 3D shapes of important objects. Then, in step S4500, the deformed stereoscopic images are interpolated using bilinear interpolation according to the deformed vertex positions and the input image pair, and displayed on the touch-sensitive display unit.

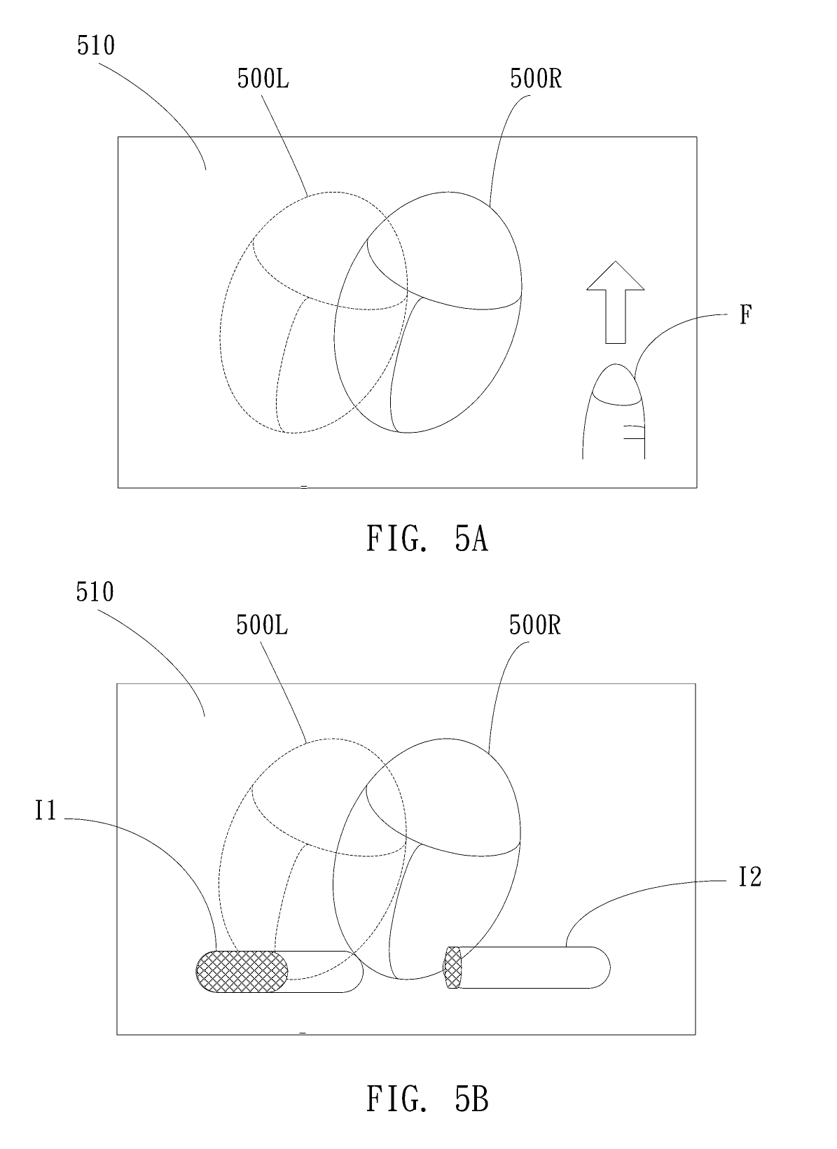

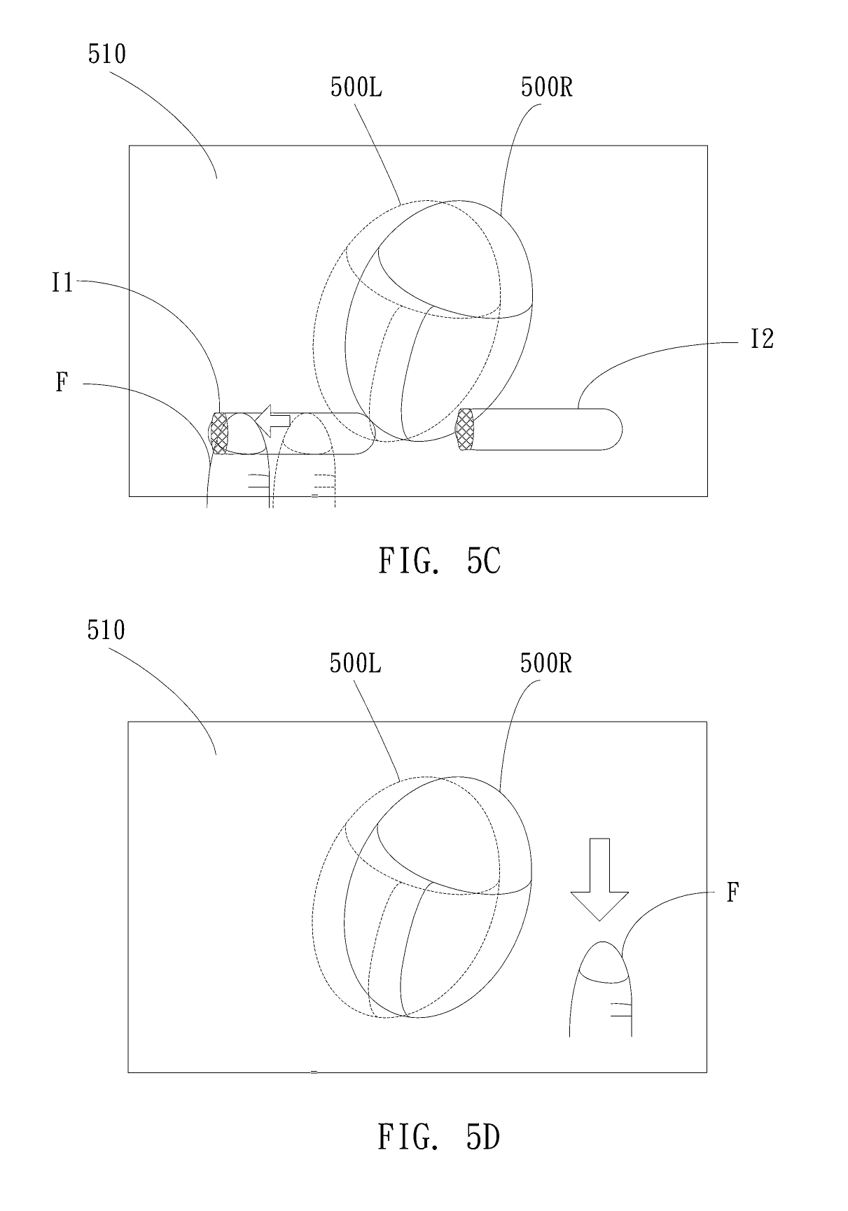

FIGS. 5A to 5D illustrate an example of an operational interface for editing stereoscopic images according to the editing method for stereoscopic images of the invention. A touch-sensitive display unit of an electronic device displays an operational interface 510, wherein the operational interface 510 displays stereoscopic images with an image pair of a left image 500L and a right image 500R. When a finger F touches the touch-sensitive display unit and moves upward (FIG. 5A), control indicators I1 and I2 are displayed in the operational interface 510, as shown in FIG. 5B. For example, the control indicators I1 and I2 can correspond to the global scaling factor and the shift factor in the disparity consistency energy, respectively. It is understood that, the control indicators I1 and I2 may have a preset value based on the optimal values of the corresponding factors. A user can use the finger F to touch and move the control indicator, thus to adjust the factor value corresponding to the touched control indicator, as shown in FIG. 5C. After editing the stereoscopic images, the finger F can touch the touch-sensitive display unit and moves downward, related control indicators are disappeared from the operational interface 510, as shown in FIG. 5D.

Furthermore, the present application can be extended to interactively edit depths of the whole scene or even a region in images. Note that it is more natural to edit depths than disparities. Thus, Eqs. (1-3 and 5) can be used to convert between depths and disparities. A graphical user interface (GUI) for interactive and direct manipulation of the stereoscopic images can be provided. In the GUI, a main window shows the editing image, and can freely switch between the original input and the edited result. Depending on the display capability, it can also switch to the left view, the right view, the anaglyph image, and the binocular image, which allows the user to view the 3D effect during editing. The user can simply drag the image boundary to adjust the size and aspect ratio, and the system displays the retargeting image interactively. Several different visualization methods are provided for depth adaptation or adjustment. The GUI shows the 3D spatial distribution of the feature points from the side and from the top. It can also display the comfort zone, and the sorted depth distribution of feature points. The comfort zone is an optional input which is found either in the specification of the target display or is determined empirically. Several options can be provided for editing depths. In the first option, the user can either specify a similarity transformation or directly draw the desired target depth distribution in the depth distribution view. The system automatically calculates the resulting disparity value for each feature point. In the second option, the user can select an area by drawing a bounding polygon and edit its 3D position and scaling factor. In all these editing operations, the system can generate the warped result and update the disparity distribution and feature locations immediately.

As mentioned, in the first option, the user first specifies the desired depth transformations for all features. This can be done by specifying 1) a 1D similarity transformation of depths, or 2) the target depth distribution. The system then converts the depths to the corresponding disparities and incorporates them into the disparity consistency energy Ψ_{c}.

It is assumed that, a similarity transformation is used. First, the disparities dᵢ of all features F={fᵢ} are converted from the pixel domain to the physical domain. Next, the depths Zᵢ are calculated from their disparities dᵢ using Eq. (6),

$${Z}_{i} = \frac{eD}{e - {d}_{i}} .$$

The target depth \hat{Z}ᵢ is calculated as \hat{Z}ᵢ=s_{z}Zᵢ+t_{z} and then converted back as the target disparity

$${\hat{d}}_{i} = e ( 1 - \frac{D}{{\hat{Z}}_{i}} )$$

using Eq. (4). After converting \hat{d}ᵢ from the physical domain to the pixel domain, the disparity consistency energy is then modified using the target disparities as

$${Ψ}_{c} = \frac{1}{n} {\sum }_{i = 1}^{n} {( {\tilde{d}}_{i} - {\hat{\tilde{d}}}_{i} )}^{2} . \qquad ( 21 )$$

If the target depth distribution is specified, the target depths \hat{Z}ᵢ are given by the user and the resulting procedure is similar. The present method also allows users to change the size and position of the object. First, the user selects features on the object by drawing a closed region. The user can then input the 3D scaling factor (sₓ, s_{y}, s_{z}) and translations (tₓ, t_{y}, t_{z}) for this object. The set of selected features \hat{F}=(fᵢ^{L}, fᵢ^{R}) is projected back to its 3D position (Xᵢ, Yᵢ, Zᵢ) using Eq. (5). Scaling and translating the 3D position accordingly yields the target 3D position \hat{X}ᵢ, Ŷᵢ, \hat{Z}ᵢ, which are projected onto both views to obtain \hat{f}ᵢ^{L} and \hat{f}ᵢ^{R} using Eqs. (1-3). For the remaining features, either Eq. (15) or (16) is used as the constraint. It is assumed that Eq. (16) is used, the disparity consistency energy is then modified as

$${Ψ}_{c} = \frac{1}{\vert \hat{F} \vert} {\sum }_{i ∈ \hat{F}}^{n} ( {‖ {\tilde{f}}_{i}^{L} - {\hat{f}}_{i}^{L} ‖}^{2} + {‖ {\tilde{f}}_{i}^{R} - {\hat{f}}_{i}^{R} ‖}^{2} ) + \frac{λ}{\vert F \backslash \hat{F} \vert} {\sum }_{i ∈ F \backslash \hat{F}} {( ( {s}_{d} {d}_{i} + {t}_{d} ) - {\tilde{d}}_{i} )}^{2} , \qquad ( 22 )$$

where λ is the weight between these two parts of energy (λ is set as 0.1). Finally, Ψ with the modified Ψ_{c} is minimized to deform the images to match the above constraints in a content-aware manner.

Therefore, the content-aware display adaptation methods and related editing interfaces and methods for stereoscopic images can simultaneously resizes a binocular image to the target resolution and adapts its depth to the comfort zone of the display while preserving the perceived shapes of prominent objects. The present method does not require depth information or dense correspondences. Given the specification of the target display and a sparse set of correspondences, the present method can efficiently deform the input stereoscopic images for display adaptation, for example, by solving a least-squares energy minimization problem. This can be used to adjust stereoscopic images to fit displays with different real estates, aspect ratios, and comfort zones. In addition, with slight modifications to the energy function, the present method allows users to interactively adjust the sizes, locations, depths of the selected objects, and/or related factors of the energy function, giving users aesthetic control for depth perception.

Content-aware display adaptation methods and related editing interfaces and methods for stereoscopic images, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A content-aware display adaptation method for stereoscopic images for use in an electronic device, comprising:
providing stereoscopic images comprising at least one image pair of a left image and a right image;
estimating saliency maps for the image pair using a saliency detection algorithm;
representing each image as a grid mesh and measuring a per-quad importance for each quad based on the saliency maps;
detecting features of the left image and the right image, and matching the detected features between the left image and the right image;
defining an energy function according to the saliency maps, the matched features, data for the grid mesh, and specification of a target display, wherein the energy function consists of at least a disparity consistency energy, which ensures the disparities of the matched features are manipulated in a consistent way; and
minimizing the energy function to obtain two sets of deformed vertex positions for the left image and the right image.

2. The method of claim 1, wherein the saliency detection algorithm comprises a graph-based visual saliency algorithm.

3. The method of claim 1, wherein the per-quad importance for each quad is measured by averaging and normalizing a per-pixel saliency based on the saliency maps.

4. The method of claim 1, wherein SIFT (Scale Invariant Feature Transform) features are detected from both the left image and the right image, and the matched features are verified using a fundamental matrix estimated using RANSAC (RANdom SAmple Consensus).

5. The method of claim 4, further comprising removing cluttered features from the detected features using non-maximum suppression.

6. The method of claim 1, wherein the energy function is minimized by solving a least-squares problem for the energy function.

7. The method of claim 1, wherein the disparity consistency energy comprises a global scaling factor of disparity and a shift factor, which are used to maintain the relative depths of the features.

8. The method of claim 1, wherein the energy function further consists of at least an alignment energy, which ensures the features are horizontally aligned on the same scanline after deformation.

9. The method of claim 1, wherein the energy function further consists of at least a distortion energy and a line bending energy, wherein the distortion energy prevents important quads in the grid mesh from being non-uniformly scaled, and the line bending energy maintains the angle between an original edge and an deformed edge corresponding to each quad to be as small as possible.

10. A content-aware display adaptation method for stereoscopic images for use in an electronic device, comprising:
providing stereoscopic images comprising at least one image pair of a left image and a right image;
estimating saliency maps for the image pair using a saliency detection algorithm;
representing each image as a grid mesh and measuring a per-quad importance for each quad based on the saliency maps;
detecting features of the left image and the right image, and matching the detected features between the left image and the right image;
defining an energy function according to the saliency maps, the matched features, data for the grid mesh, and specification of a target display, wherein the energy function consists of at least an alignment energy, which ensures the features are horizontally aligned on the same scanline after deformation; and
minimizing the energy function to obtain two sets of deformed vertex positions for the left image and the right image.

11. A machine-readable storage medium comprising a computer program, which, when executed, causes a device to perform a content-aware display adaptation method for stereoscopic images, wherein the method comprises:
providing stereoscopic images comprising at least one image pair of a left image and a right image;
estimating saliency maps for the image pair using a saliency detection algorithm;
representing each image as a grid mesh and measuring a per-quad importance for each quad based on the saliency maps;
detecting features of the left image and the right image, and matching the detected features between the left image and the right image;
defining an energy function according to the saliency maps, the matched features, data for the grid mesh, and specification of a target display, wherein the energy function consists of at least a disparity consistency energy, which ensures the disparities of the matched features are manipulated in a consistent way; and
minimizing the energy function to obtain two sets of deformed vertex positions for the left image and the right image.

12. A machine-readable storage medium comprising a computer program, which, when executed, causes a device to perform a content-aware display adaptation method for stereoscopic images, wherein the method comprises:
providing stereoscopic images comprising at least one image pair of a left image and a right image;
estimating saliency maps for the image pair using a saliency detection algorithm;
representing each image as a grid mesh and measuring a per-quad importance for each quad based on the saliency maps;
detecting features of the left image and the right image, and matching the detected features between the left image and the right image;
defining an energy function according to the saliency maps, the matched features, data for the grid mesh, and specification of a target display, wherein the energy function consists of at least an alignment energy, which ensures the features are horizontally aligned on the same scanline after deformation; and
minimizing the energy function to obtain two sets of deformed vertex positions for the left image and the right image.

13. An editing method for stereoscopic images for use in an electronic device, comprising:
displaying an operational interface on a touch-sensitive display unit of the electronic device, wherein the operational interface displays stereoscopic images comprising at least one image pair of a left image and a right image, and has at least one control indicator;
receiving an input corresponding to the control indicator via the touch-sensitive display unit;
modifying an energy function based on the input, wherein the energy function is defined according to saliency maps, matched features for the stereoscopic images, data for a grid mesh corresponding to each image, and specification of the touch-sensitive display unit;
minimizing the energy function to obtain two sets of deformed vertex positions of the grid mesh for the left image and the right image; and
displaying the deformed stereoscopic images on the touch-sensitive display unit based on the deformed vertex positions.

14. The method of claim 13, wherein the energy function consists of at least a disparity consistency energy, which ensures the disparities of the matched features are manipulated in a consistent way, and the disparity consistency energy comprises a global scaling factor of disparity or a shift factor, which are used to maintain the relative depths of the features, in which the control indicator corresponds to the global scaling factor or the shift factor.

15. The method of claim 13, wherein the input is performed by touching and scrolling the control indicator of the operational interface on the touch-sensitive display unit.

16. A machine-readable storage medium comprising a computer program, which, when executed, causes a device to perform an editing method for stereoscopic images, wherein the method comprises:
displaying an operational interface on a touch-sensitive display unit of the electronic device, wherein the operational interface displays stereoscopic images comprising at least one image pair of a left image and a right image, and has at least one control indicator;
receiving an input corresponding to the control indicator via the touch-sensitive display unit;
modifying an energy function based on the input, wherein the energy function is defined according to saliency maps, matched features for the stereoscopic images, data for a grid mesh corresponding to each image, and specification of the touch-sensitive display unit;
minimizing the energy function to obtain two sets of deformed vertex positions of the grid mesh for the left image and the right image; and
displaying the deformed stereoscopic images on the touch-sensitive display unit based on the deformed vertex positions.
